(19) United States
(12) Patent Application Publication
(10) Pub. No.: US 2008/0031539 A1
(43) Pub. Date: Feb. 7, 2008

(54) Derivative image domain

(75) Inventor: Scott J. Daly, Kalama, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/655,542

(22) Filed: Jan. 19, 2007

Related U.S. Application Data
(60) Provisional application No. 60/835,238, filed on Aug. 2, 2006.

(51) Int. Cl. G06K 9/40

(52) U.S. Cl. 382/274; 382/260

(57) ABSTRACT

A method of processing an image includes receiving an image to be displayed. Then at least one selective region of the image that has a transition from at least one of dark to bright and bright to dark is determined. The image is modified to include additional information so as to increase the perceived dynamic range of the image proximate the transition when the image is displayed on a display.

### CROSS-REFERENCE TO RELATED APPLICATIONS

This application claims the benefit of U.S. Provisional Ser. No. 60/835,238 filed Aug. 2, 2006.

### BACKGROUND OF THE INVENTION

The present invention relates to image modification to enhance the apparent dynamic range of the image.

Light emitting displays, and in particular liquid crystal displays, are designed to present an image to the viewer. The contrast ratio of an image being displayed may be characterized as the ratio of the brightest pixel to the darkest pixel that the particular display can display.

It is desirable to increase the contrast ratio of the display, otherwise generally referred to as the dynamic range of the display, to increase the legibility of the display under a greater range of lighting conditions. There are principally three principal techniques used to increase the dynamic range of the display. The first technique includes improving the characteristics of the liquid crystal material. Unfortunately, it takes substantial time and expense to develop improved liquid crystal materials. The second technique involves using longer light paths through the liquid crystal materials which may increase the dynamic range by lowering the black point. Unfortunately, it may be inefficient, complex, and expensive to cascade two liquid crystal stacks together. The third technique includes using an active backlight array (e.g., light emitting diode array) where selective backlights may be decreased or otherwise turned off. Unfortunately, it is complex and expensive to incorporate an active backlight array.

It is desirable to have a cost effective technique to increase the dynamic range of the display observed by a viewer.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a mach band effect with eyes superimposed.

FIG. 2 illustrates a mach band effect without eyes superimposed.

FIG. 3 illustrates a mach band effect as a cross-section of luminance.

FIG. 4 illustrates a mach band effect on an image.

FIG. 5 illustrates a calculation of the mach band effects.

FIG. 6 illustrates one technique to generate mach band effects within pictorial images.

FIG. 7 illustrates another technique to generate mach band effects within pictorial images.

FIG. 8 illustrates another technique to generate mach band effects within pictorial images.

### DETAILED DESCRIPTION OF PREFERRED EMBODIMENT

Modification of the display architecture or otherwise the materials within a liquid crystal display is burdensome, complex, and expensive. Without modification of the physical properties of the display itself, it was determined that the optical and neural properties of the human visual system may be used to provide the appearance to the viewer of a greater contrast ratio than physically achievable by the display itself.

An effect exists, generally referred to as mach bands where bands adjacent to a light to dark gradient appear lighter or darker than justified by the underlying light. The effect is one of increased, local, perceived brightness on either side of a luminance gradient. It is usually supposed that this effect is caused by lateral inhibition of the receptors in the eye. An alternative explanation is that the effect is explained by the fundamentally statistical strategy of visual perception, representing the common occurrence of highlights and lowlights in association with luminance gradients.

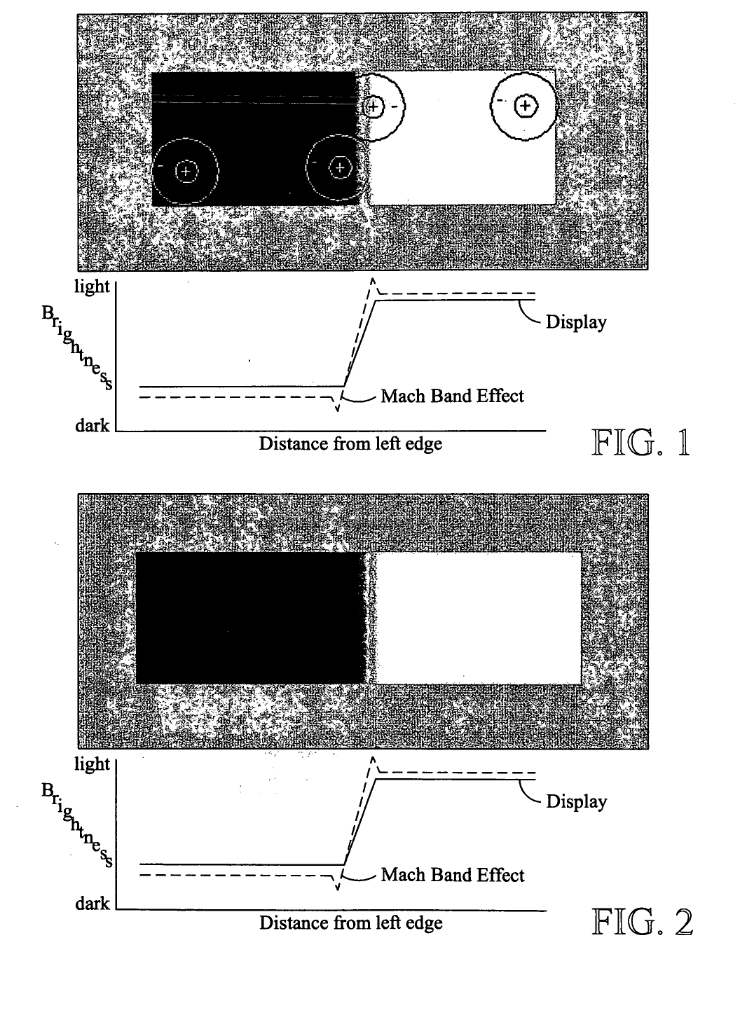

Referring to FIG. 1, the receptive fields of the eye are represented as a disk (+) and annulus (−). The center disk is an excitatory area and the annulus an inhibitory area. The receptive fields in the uniformly white and uniformly black areas receive about the same stimulation in their excitatory centers and inhibitory surrounds. Therefore the center excitations are in balance with the surround inhibitions.

The receptive field over the bright side of the transition gives a stronger response in the center because part of the surround is in the darker area. Therefore the receptive field receives less inhibition from the surround than did the center at the extreme left and right ends. The receptive field over the dark side of the transition receives more surround inhibition because part of the surround is in the brighter area. Therefore, the excitatory response is less and this results in the viewer seeing that the area as darker.

Referring to FIG. 2 the mach band effect is shown where the solid curve represents the amount of light being displayed. The dashed curve represents the brightness that is usually perceived by the viewer. To the left of the point where the figure just starts to get lighter the viewer usually sees a dark bar that is slightly darker than the area to the left of it. At the point where the brightness just stops increasing, people usually perceive a bright bar.

The Mach bands effect provides a perceptual increase in the contrast ratio of the display, and in effect increase the perceptual dynamic range of the display, which improves the properties of displayed images without having to change the physical properties of the display.

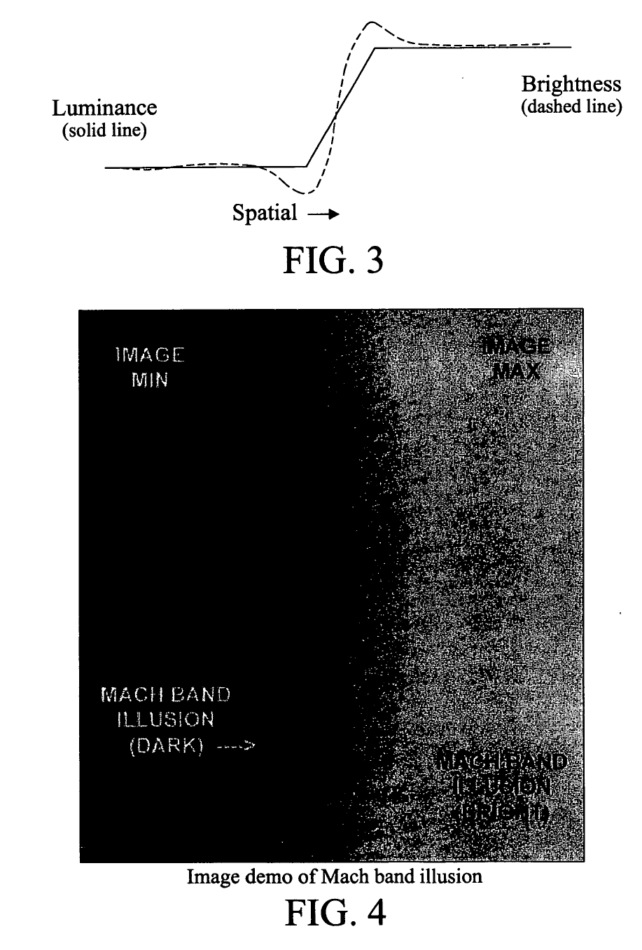

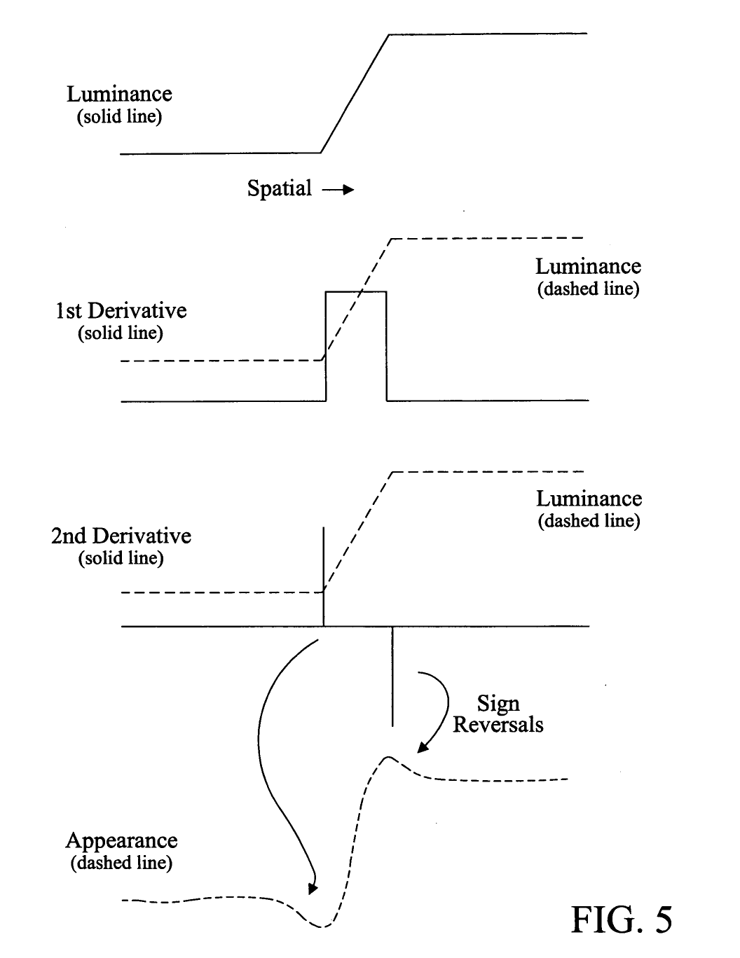

Referring to FIG. 3, the high valued second order derivatives of an image (sudden slope changes) are the regions that appear either brighter or dimmer than the actual luminance. The curved mach band effect is illustrated to indicate that the geometry does not necessarily need to be geometrically linear. An image version of the mach band effect is illustrated in FIG. 4. The particular type of waveform that generally results in a mach band effect is illustrated in FIG. 5. The first derivative is shown which is indicative of the slope of the image data. The second derivative is shown which is indicative of changes in the slope of the first derivative. It may be observed that there is a negative correlation between the second derivative extrema and the positions of the mach band effects. It is noted that in many images the first and second derivatives tend to be blurred in appearance. In some cases, the blurring has the appearance of a Gaussian blob.

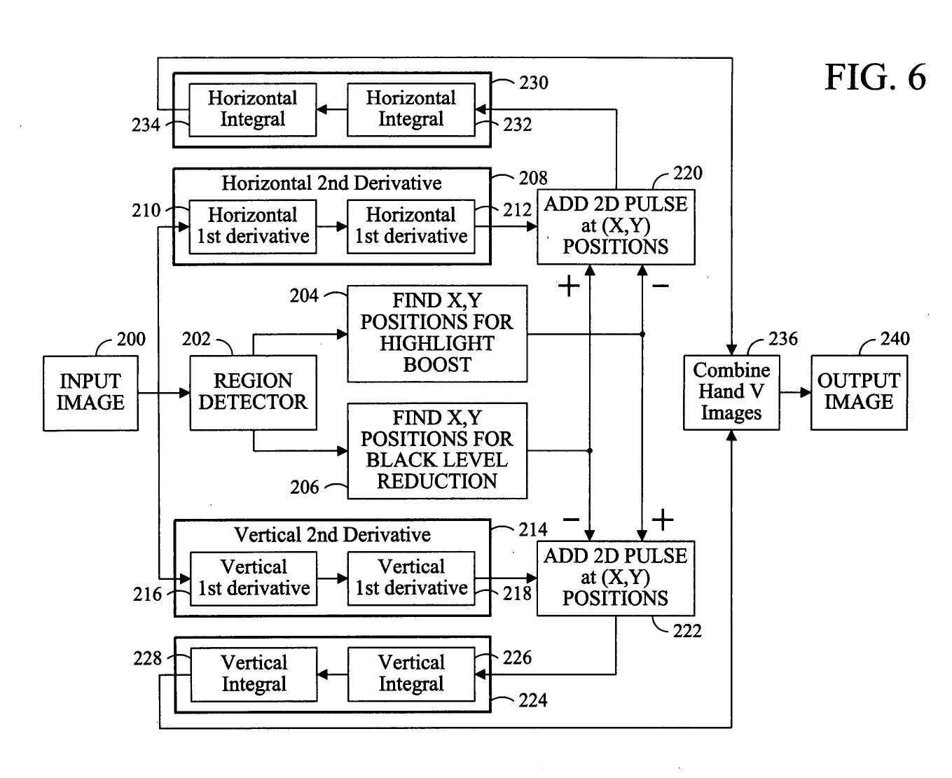

Referring to FIG. 6, one implementation to selectively induce mach band effects includes receiving an input image 200. A region detector 202 segments the image 200 in a manner that different regions of generally bright areas are identified and regions of generally dark areas are identified. The regions of the image suitable for a highlight boost are identified 204. The regions of the image suitable for a black level reduction are identified 206.

It was determined that the image may have regions that could benefit from the mach band effect which may be generally horizontal, generally vertical, in another general direction (including curved), or have a spatial shape such as a mesa. The input image 200 is provided to a horizontal second derivative process 208. The horizontal second derivative process 208 includes a first horizontal derivate 210 from which is obtained a second horizontal derivative 212. The input image 200 is provided to a vertical second derivative process 214. The vertical second derivative process 214 includes a first vertical derivate 216 from which is obtained a second vertical derivative 218. Other identification mechanisms may likewise be used that are, for example, directional or spatial in nature.

The output of the horizontal second derivative process 208 is combined with the output of the highlight boost 204 and black level reduction 206 to provide a second derivative pulse 220 at the respective locations. Also, the horizontal pulse provided to the image is in the proper polarity. Similarly, the output of the vertical second derivative process 214 is combined with the output of the highlight boost 204 and black level reduction 206 to provide a second derivative pulse 222 at the respective locations. Also the vertical pulse provided to the image is in the proper polarity. With these modifications, the image has been changed in such a manner as to incorporate additional effects that all result in mach regions that were not otherwise in the image.

The image should be converted from the second derivative domain back to the image domain, and integration may be used for this purpose. The output of the second derivative pulse process 222 is provided to a vertical second integral process 224. The second integral process 224 includes a first vertical integral 226 and a second vertical integral 228. The result is to modify the image from the second derivative pulse process 222 domain back to the original image domain together with the additional information that will result in desirable mach band effects for vertical directions. The output of the second derivative pulse 220 process is provided to a horizontal second integral process 230. The second integral process 230 includes a first horizontal integral 232 and a second horizontal integral 234. The result is to modify the image from the second derivative pulse process 220 domain back to the original image domain together with the additional information that will result in desirable mach effect for the horizontal direction. The output of the horizontal and vertical integral processes 224 and 230 are combined 236. The result is provided as an output image 240 with the desirable mach band effects so as to increase the apparent dynamic range of the image 240 to a viewer.

While the technique of calculating derivates and subsequently integrating the image is functional it tends to be prone to noise in the image, the image spatial resolution may be inadequate for accurate calculations, and the localized DC levels should be retained. In order to reduce some of these effects, a similar process may be used, but primarily focus on just transforming the image to include the added extreme for boost purposes to the image domain.

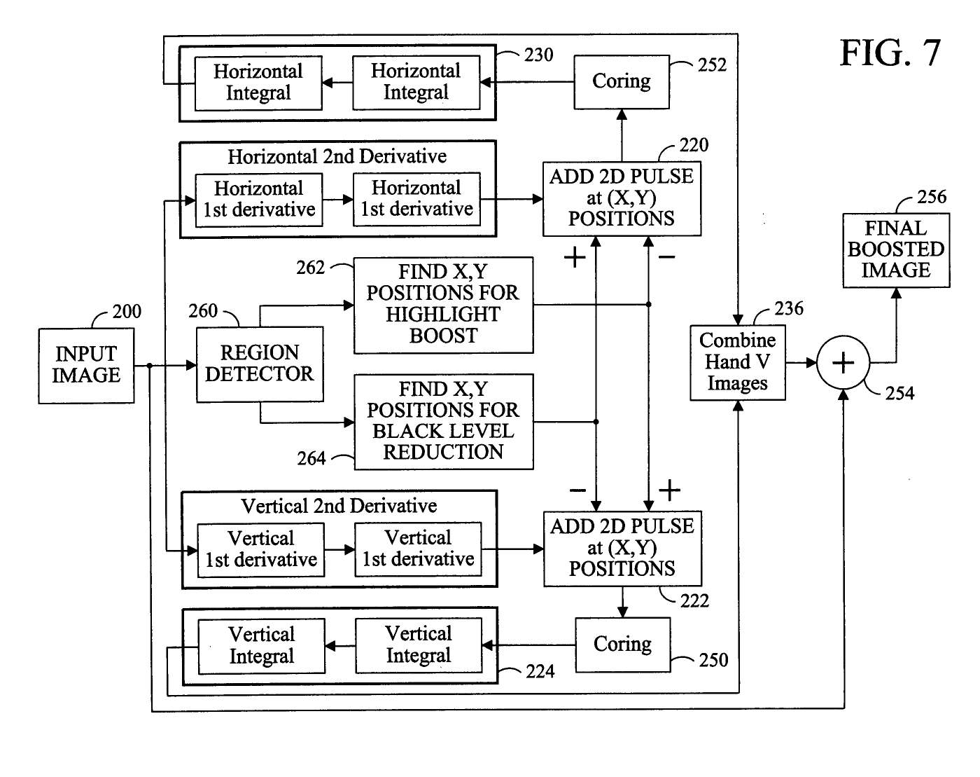

Referring to FIG. 7, one technique to achieve a more accurate image modification is to focus on primarily transforming the added extreme and not the rest of the image for boost purposes. In particular, the image is processed to determine those regions that may benefit by a boosting process, modify the transformed image with “boost” data, and convert the relevant image portions back. To facilitate this modification a coring processes 250 and 252 may be included to process the output of the pulse processes 220 and 222. The coring process removes modulations below a certain absolute value amplitude (where the signal has a mean level of zero). Thus the coring process removes most or all of the input image components and primarily returns the generated mach band components. The integral processes 224 and 230 operate effectively to convert less than the entire image which has data to be converted or primarily output the mach data. The input image 200 is added back at process 254 to the output of the combination 236 to obtain the final boosted image 256.

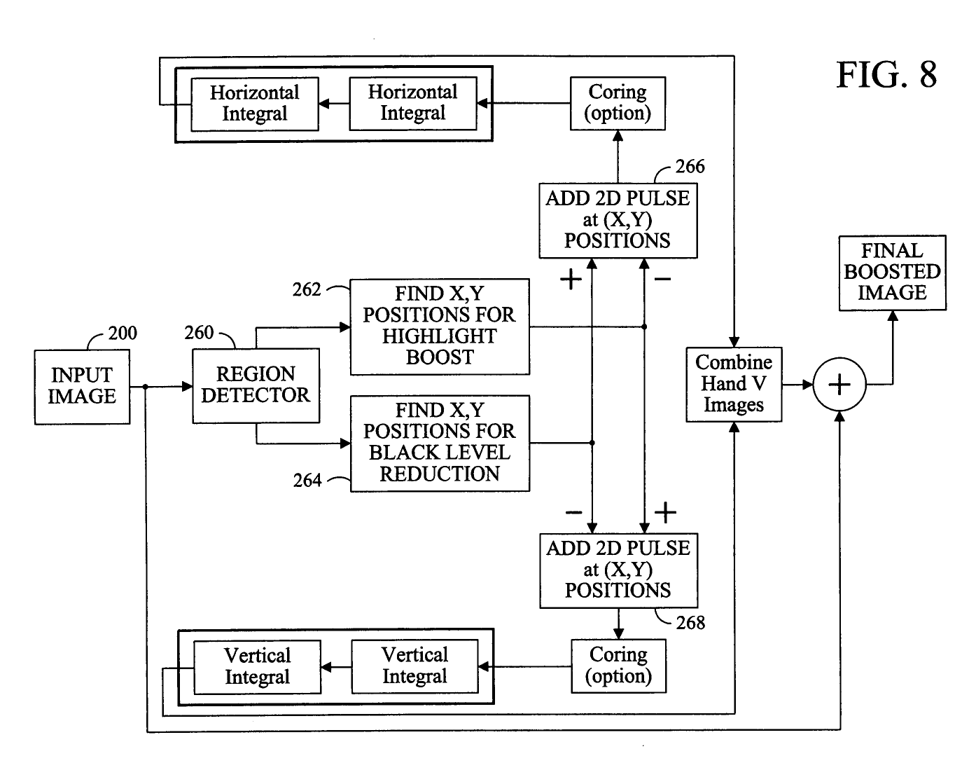

Referring to FIG. 8, another technique to achieve improved apparent contrast ratio is to process the image to determine where the mach band effect should be included, the amount of mach band effect to be included, and with what polarity the mach band effect should be included. The input image 200 is provided to a region detector 260. The region detector processes the image to determine regions that are suitable for including the mach effect. The positions for the boost 262 and reduction 264 are determined in addition to the amount of mach effect to include. The horizontal pulse process 266 and vertical pulse process 268 incorporate the desirable mach band pulses into the image. The remainder of the process is as shown in FIG. 7.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method of processing an image comprising:
(a) receiving an image to be displayed;
(b) determining at least one selective region of said image that has a transition from at least one of dark to bright and bright to dark;
(c) modifying said image to include additional information so as to increase the perceived dynamic range of said image proximate said transition when said image is displayed on a display.

2. The method of claim 1 wherein said increased perceived dynamic range of said at least one of said transitions is a mach band effect.

3. The method of claim 1 wherein said determining selective regions is using a region detector.

4. The method of claim 1 wherein said additional information has different polarities depending based upon whether said dark to bright or bright to dark.

5. The method of claim 1 wherein said increased dynamic range is the result of perceived black level reduction.

6. The method of claim 1 wherein said increased dynamic range is the result of increased perceived highlight level.

7. The method of claim 1 wherein said determining determines at least one region of said image that has a transition from dark to bright, and determines at least one region of said image that has a transition from bright to dark.

8. The method of claim 7 wherein said modifying said image to include additional information is in a first direction and a second direction.

9. The method of claim 8 wherein said additional information is integrated.

10. The method of claim 9 wherein said integrated additional information is included together with said image.

11. The method of claim 10 wherein said integrated additional information does not include other significant information for said image.

12. The method of claim 1 wherein said dark and bright are relative shades of grey.

13. A method of processing an image comprising:
(a) receiving an image to be displayed;
(b) determining at least one selective region of said image that has a transition from at least one of a first level to a second level;
(c) modifying said image to include additional information so as to increase the perceived dynamic range of said image proximate said transition when said image is displayed on a display.

14. The method of claim 13 wherein said increased perceived dynamic range of said at least one of said transitions is a mach band effect.

15. The method of claim 13 wherein said determining selective regions is using a region detector.

16. The method of claim 13 wherein said additional information has different polarities depending based upon whether said first and second levels are dark to bright or bright to dark.

17. The method of claim 13 wherein said increased dynamic range is the result of perceived black level reduction.

18. The method of claim 13 wherein said increased dynamic range is the result of increased perceived highlight level.

19. The method of claim 13 wherein said determining determines at least one region of said image that has a transition from dark to bright, and determines at least one region of said image that has a transition from bright to dark.

20. The method of claim 19 wherein said modifying said image to include additional information is in a first direction and a second direction.

21. The method of claim 20 wherein said additional information is integrated.

22. The method of claim 21 wherein said integrated additional information is included together with said image.

23. The method of claim 22 wherein said integrated additional information does not include other significant information for said image.
